(19) United States
(12) Patent Application Publication
(10) Pub. No.: US 2012/0128291 A1
(43) Pub. Date: May 24, 2012

(54) FORMATION OF REFLECTIVE SURFACES IN PRINTED CIRCUIT BOARD WAVEGUIDES

(75) Inventors: Michael E. Teitelbaum, Elkton, MD (US); Keith Goossen, Howell, NJ (US); Eric D. Wetzel, Baltimore, MD (US); Daniel O'Brien, Hydes, MD (US)

(73) Assignees: ARMY RESEARCH LABORATORY, Aberdeen Proving Ground, MD (US); UNIVERSITY OF DELAWARE, Newark, DE (US)

(21) Appl. No.: 13/321,223

(22) PCT Filed: May 27, 2010
(86) PCT No.: PCT/US2010/036367

§ 371 Date: Feb. 8, 2012

Related U.S. Application Data
(60) Provisional application No. 61/181,493, filed on May 27, 2009.

(51) Int. Cl. G02B 6/12; B23P 11/00

(52) U.S. Cl. 385/14; 29/428

(57) ABSTRACT

The present invention relates to an apparatus and method for creating an printed circuit board including one or more waveguides having one or more reflective surfaces. Waveguides are embedded within a printed circuit board. A reflective surface is formed within the embedded waveguides by mechanically milling the printed circuit board. The reflective surfaces enable intra chip, chip-to-chip, or chip-to-component optical interconnections through the waveguides embedded within the printed circuit board.

### CROSS REFERENCE TO RELATED APPLICATIONS

This application claims priority to U.S. Provisional Application Ser. No. 61/181,493, filed May 27, 2009, which is incorporated herein, in its entirety, by reference.

### STATEMENT REGARDING FEDERALLY SPONSORED RESEARCH

Research leading to this application received funding from the Army Research Labs under Cooperative Agreement Number W911NF-06-2-011. The Government may have rights in this invention.

### BACKGROUND OF THE INVENTION

As clock speeds and integration densities for processor units increase there is growing demand for high-speed data bussing within printed circuit boards (PCBs) to interconnect the processor units on the PCBs. Electrical interconnects will be unlikely to meet bandwidth requirements of systems built around these processor units. Due to this problem, the integration of optical waveguides into printed circuit boards to serve as is parallel optical interconnects (POI) has been explored.

One hurdle in the integration of optical waveguides into printed circuit boards is developing an efficient and cost-effective technique for coupling out-of-plane light sources and detectors with the integrated/embedded waveguides.

### SUMMARY OF THE INVENTION

The present invention is embodied in the methods and apparatus for forming one or more reflective surfaces in one or more waveguides within a printed circuit board. The reflective surfaces may be formed by embedding at least one waveguide within the printed circuit board and forming at least one reflective surface in the at least one embedded waveguide using a mechanical mill. The apparatus may include a printed circuit board, at least one waveguide embedded within the printed circuit board, and a mechanically milled cavity within the printed circuit board that intersects the at least one waveguide to form at least one angled end on the at least one waveguide.

### BRIEF DESCRIPTION OF THE DRAWINGS

The foregoing summary, as well as the following detailed description of exemplary embodiments of the invention, may be better understood when read in conjunction with the appended drawings, which are incorporated herein and constitute part of the specification. For the purposes of illustrating the invention, there is shown in the drawing, exemplary embodiments of the present invention. It will be understood, however, that the invention is not limited to the precise arrangements and instrumentalities shown. In the drawings, the same reference numerals are employed designating the same elements throughout the several figures. When a plurality of similar elements are present, a single reference numeral may be assigned to the plurality of similar elements with a small letter designation referring to specific elements. When referring to the elements collectively or to a non-specific one or more of the elements, the small letter designation may be dropped. In the drawings:

FIG. 1 is a cross-sectional end view of a printed circuit board with embedded waveguides prior to mechanically milling to form one or more internal reflection mirrors in one or more of the waveguides in accordance with an exemplary embodiment of the present invention;

FIG. 2A is a cross-sectional side view of the printed circuit board of FIG. 1 during mechanical milling to form an angled end in a waveguide in accordance with an aspect of the present invention;

FIG. 2B is a top view of a printed circuit board after mechanical milling in accordance with one aspect of the present invention;

FIG. 2C is a top view of a printed circuit board after mechanical milling in accordance with another aspect of the present invention;

FIG. 3 is a bottom perspective view of an optical printed circuit board attached to a driver chip including six waveguides with six internal reflection mirrors embedded within the printed circuit board and attached to a component chip in accordance with an exemplary embodiment of the present invention;

FIG. 4 is a top perspective view of the optical printed circuit board attached to a driver chip of FIG. 3;

FIG. 5 is a flowchart of exemplary steps for forming the optical printed circuit board of FIGS. 3 and 4 in accordance with aspects of the present invention; and

FIG. 6 is a schematic diagram of leakage through an internal reflection mirror formed in accordance with aspects of the present invention.

### DETAILED DESCRIPTION OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

Aspects of the present invention are directed to forming at least one reflective surface in at least one embedded optical waveguide by using a mechanical mill. This enables production of cost effective optically integrated printed circuit boards that can be used for intra chip, chip-to-chip, or chip-to-component communication through the printed circuit boards.

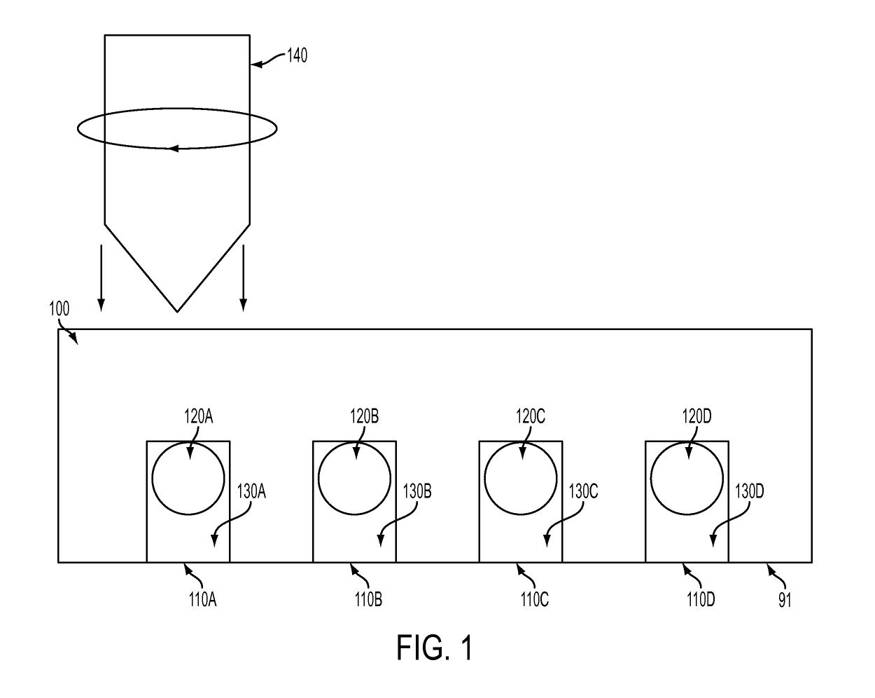

FIG. 1 depicts a printed circuit board 100 having multiple waveguides 120 (four waveguides 120A-D illustrated) embedded within the printed circuit board 100 prior to mechanical milling in accordance with an aspect of the present invention, e.g., using mill 140. In the illustrated embodiment, the waveguides 120 are positioned within respective grooves 110 and filled with epoxy 130. In an exemplary embodiment, the waveguides 120 may be optical fibers such as a plastic optical fibers.

In accordance with one example, the grooves 110 are about 250 μm wide and about 500 μm deep. The grooves 110 may be separated by approximately 250 μm such that the pitch of the grooves, and thus the waveguides, is about 500 μm. It will be understood by one of skill in the art form the description herein that grooves and waveguides with other dimensions may be used.

The mill 140 mechanically mills the printed circuit board 100 such that a tip 142 of the mill 140 passes though the printed circuit board 100 and intersects one or more of the waveguides 120 to create an angled end on the one or more waveguides 120. In an exemplary embodiment, the mill 140 has a 90 degree tip and a diameter that is substantially larger than the diameter of the waveguides 120, such that a substantially flat surface is created on an end of the waveguide having a 45 degree angle with respect to an axis extending thorough the center of the waveguide after the mill 140 intersects the waveguides 120. In an alternative exemplary embodiment, the mill is a straight end mill (not shown) that passes thought the printed circuit board 100 and waveguides 120 at a 45 degree angle with respect to a planar surface 91 of the printed circuit board 100 such that a substantially flat surface is created on an end of the waveguide having a 45 degree angle with respect to an axis extending thorough the center of the waveguide after the mill intersects the waveguides 120. It will be understood by one of skill in the art from the description herein that the end mill may have a tip angle other than 90 degrees or 0 degrees, with the tip angle and/or milling angle being selected to form desired angles on the ends of the waveguides. It will also be understood by one of skill in the art from the description herein that the end mill is not limited to angular shapes and may also include curvatures with the tip being chosen to form desired curvatures on the ends of the waveguides. In an exemplary embodiment, the angled end forms an internal reflection mirror, e.g., a total internal reflection mirror having leakage through the reflective surface of −10 dB compared to a 90 degree angle on the end of the waveguide.

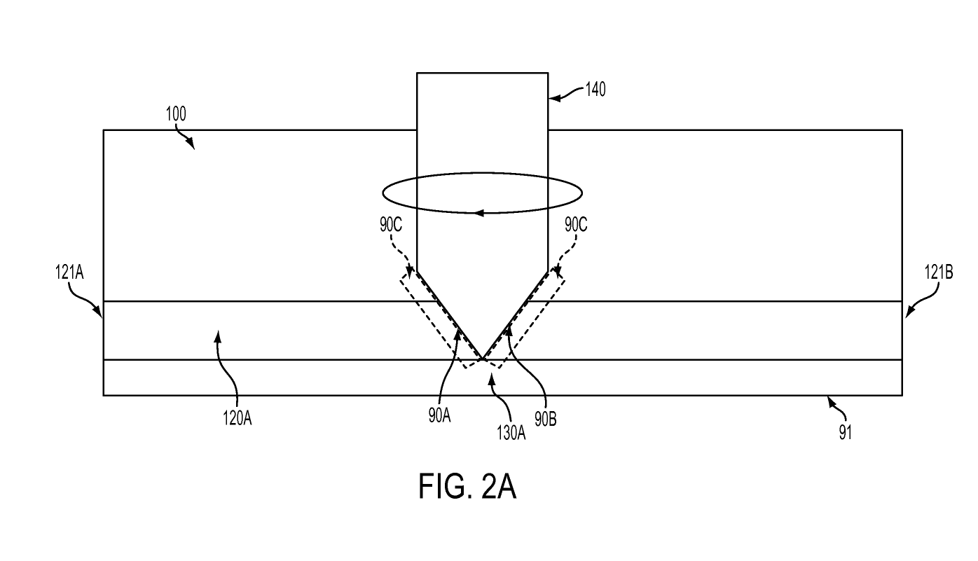

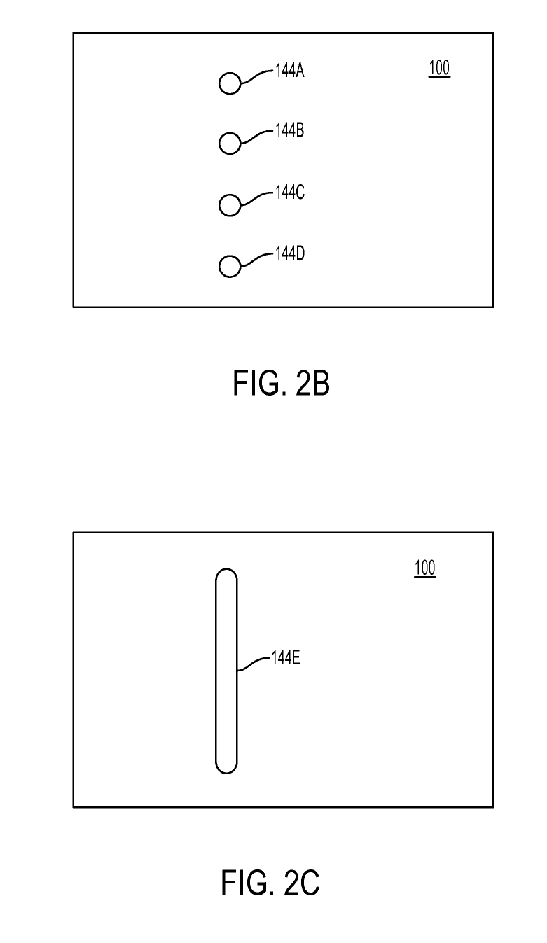

FIG. 2A depicts the printed circuit board 100 during mechanical milling in accordance with an aspect of the present invention. During mechanical milling, a cavity is created in the printed circuit board 100 that intersects one or more of the waveguides to form one or more angled ends. In the illustrated embodiment, mechanical milling is performed using the mill 140. The mill 140 passes through the printed circuit board 100 and intersects with a first of the waveguides 120A. In the illustrated embodiment, a first angled end 90A and a second angled end 90B are formed during the milling. In an exemplary embodiment, the milled first angled end 90A and/or second angled end 90B form an internal reflection mirror such as a total internal reflection mirror. In an alternative embodiment, an optional reflective material 90C such as a metallic material is positioned (e.g., coated or deposited) on the first and/or second angled end 90A/90B to form a reflective surface.

The internal reflection mirrors and reflective surfaces direct waves into and/or out of the waveguides 120. In an exemplary embodiment, the waves are directed into and/or out of the waveguides 120 at an angle substantially normal, e.g., ±5 degrees, to a planar surface 91 of the printed circuit board 100.

In one embodiment, as depicted in FIG. 2B, the mechanically milled cavity may be one or more holes. In accordance with this embodiment, the mill 140 creates multiple holes (represented by holes 144A-D) where each hole intersects a respective waveguide to create an internal reflection mirror on each of the waveguides 120. In an alternative exemplary embodiment, as depicted in FIG. 2C, the mechanically milled cavity may be a groove 144E. In accordance with this embodiment, the mill 140 may create the groove 144E that intersects one or more of the waveguides 120. To create the groove 144E, the mill 140 may be inserted into the printed circuit board 100 to a desired depth and then drawn across the printed circuit board 100 parallel to a top surface of the printed circuit board to create a groove 144E having a uniform depth that intersects the one or more waveguides 120 to create an angled end on the one or more waveguides 120.

In one embodiment, one or both ends of each waveguide 120 are intersected by the mill 140 to form one or more angled ends on the waveguides. The milled angled ends may form internal reflection mirrors such as a total internal reflection mirrors or an optional reflective material may be positioned on the angled ends to form a reflective surface. In another embodiment, the mill may form a cavity separating the waveguides 120 into two parts and angled ends may simultaneously be formed on both parts of the waveguides 120 during the formation of the cavity. For example, as depicted in FIG. 2A, when mill 140 passes though printed circuit board 100 and intersects waveguide 120A, waveguide 120A is separated into a first part 121A and a second part 121B with each part having an angled end 90A/90B where the mill 140 contacted the respective part during the formation of the cavity.

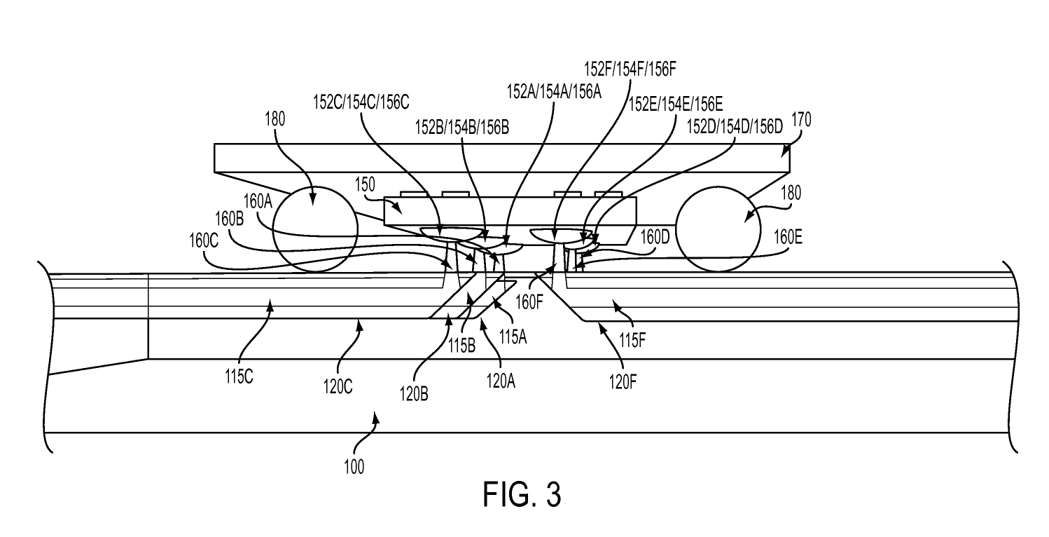

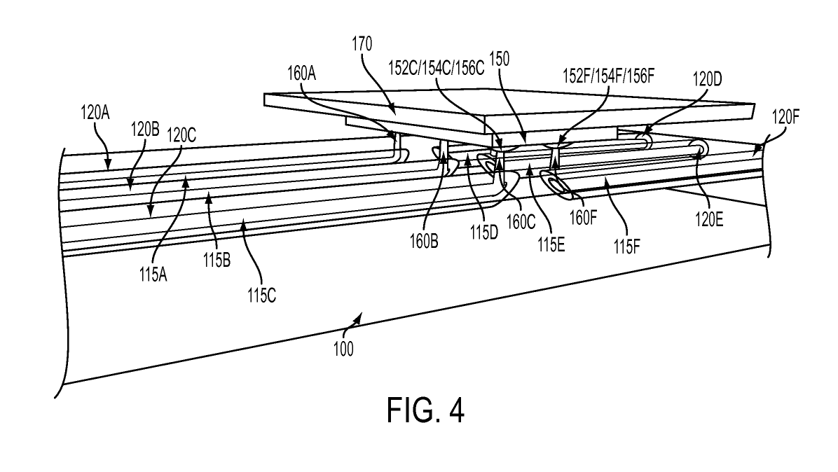

After forming internal reflection mirrors or angled ends with reflective surfaces in the embedded waveguides, the printed circuit board 100 may be connected to another printed circuit board and/or to other components as desired. As shown in FIGS. 3 and 4, the printed circuit board 100 may be coupled to an integrated circuit chip 150. The chip 150 may be a vertical-cavity surface-emitting laser (VCSEL) chip mounted to a complimentary metal-oxide semiconductor (CMOS) driver chip 170. In the illustrated embodiment, chip 150 is physically positioned above the printed circuit board 100 by attaching driver chip 170 to printed circuit board 100 through bonding elements 180 of a ball grid array. This allows chip 150 to send optical signals to other chips or components 150 via the printed circuit board 100 to provide chip-to-chip or chip-to-component optical interconnections.

Chip 150 may include multiple receivers and/or transmitters (such as six receivers 152A-F, six transmitters 154A-F, or six receiver/transmitters 156A-F). Optical signals 115 traveling through waveguides 120 that impinge upon internal reflection mirrors or reflective surfaces in the waveguides are reflected out of waveguides 120 as interconnection optical signals 160 for receipt by optical receiver 152. Likewise, interconnection optical signals 160 transmitted by optical transmitters 154 that impinge upon internal reflection mirrors or reflective surfaces in the waveguides are reflected into the waveguides 120. For example, an optical signal 115C traveling through waveguide 120C that impinges on an internal reflection mirror is reflected toward an optical receiver 152C. Likewise, an interconnection optical signal 160F transmitted by transmitter 154F that impinges on an internal reflection mirror in waveguide 120F is reflected into waveguide 120F.

In an exemplary embodiment with receivers 152 having an approximately 500 μm square receiver surface and printed circuit boards having waveguides with a diameter of approximately 250 μm and a waveguide pitch of 500 μm, it is desirable to align the receivers/transmitters 152/154/156 in a plane that is spaced vertically about 1.8 mm or less from the waveguide plane to minimize optical leakage and cross-talk between optical signals 160 emitted from adjacent waveguides toward the receivers/transmitters 152/154/156. Additionally, it is desirable for the receivers/transmitters 152/154/156 to be spaced horizontally about 100 μm or less from respective internal reflection mirrors.

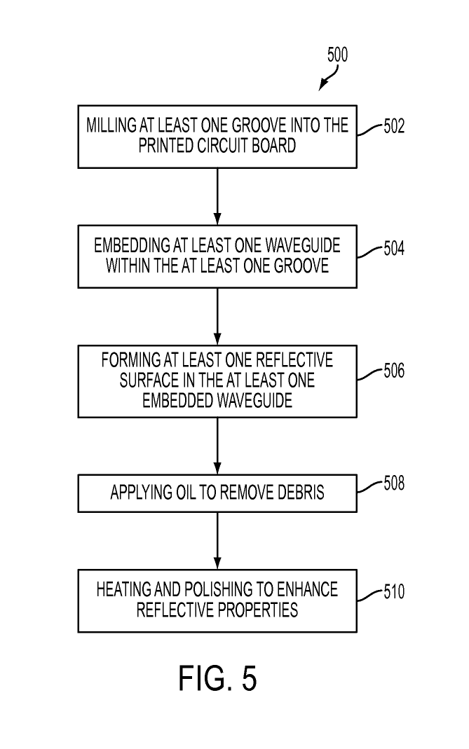

FIG. 5 is a flowchart 500 depicting exemplary steps for forming internal reflection mirrors on waveguides embedded within a printed circuit board. The steps depicted in FIG. 5 will be described with reference to FIGS. 1-4.

At step 502, at least one groove 110 is mechanically milled into the printed circuit board 100. This technique is compatible with printed circuit board writing tools that are used to create grooves in conventional circuit boards such as N.A.M.A Grade FR-4 printed circuit boards, and therefore can be easily integrated into traditional printed circuit board manufacturing processes. In one example, grade FR-4 printed circuit board plates with dimensions of 125 mm×125 mm and a 1 mm thickness may be used to create a printed circuit board 100. To mill the grooves, a 250 micrometer-diameter square-end mill may be plunged to a depth of 500 micrometers into the board and swept along the desired path using a computer-controlled milling machine.

Four parallel grooves 110 are depicted in FIG. 1. Although the grooves are shown from an end-view perspective in FIG. 1 and therefore appear to be in a straight line, it is understood in the present invention allows the grooves to be cut in essentially any pattern, including 90 degree in-plane bends. This makes this technique applicable to non-straight optical pathways. There may be any number of grooves that are cut using the process and these may be created throughout the printed circuit board at any starting point as needed in accordance with design specifications for a printed circuit board.

At step 504, at least one waveguide 120 is embedded within a respective groove 110. As shown in FIG. 1, the waveguide 120 is positioned within the groove 110. In one example, Super ESKA SK-10 plastic optical fiber 120 (available from Industrial Fiber Optics of Tempe, Ariz.) with a diameter of 250 micrometers and a core diameter of 240 micrometers may be manually placed in the grooves 110. Alternatively, the process of placing the plastic optical fibers 120 into the grooves 110 may be automated. The core material of the plastic optical fibers 120 may be made of polymethyl methacrylate (PMMA) having an index of 1.49 with NA=0.5. The cladding may be a fluorinated polymer. Transmission loss at 650 nm is −0.015 dB/cm.

After placing the optical fibers 120 in the grooves 110, the remaining void space in the grooves may be filled with epoxy 130 such as a low-viscosity epoxy to encapsulate the optical fiber 120 and hold it firmly in place. In one example, the epoxy 130 used was TRA-CON 931-1 (available from TRA-CON of Billerica, Mass.). In this exemplary embodiment, the epoxy 130 was allowed to cure overnight. Other suitable epoxies and curing techniques will be understood by one of skill in the art from the description herein.

At step 506, at least one reflective surface is formed in the at least one waveguide embedded within the printed circuit board 110 using a mechanical mill. A mechanical mill 140 may be used to create at least one angled end 90A/90B on at least one waveguide 120. In one embodiment, the at least one angled end forms an internal reflection mirror such as a total internal reflection mirror for directing waves into and/or out of the waveguides 120. In an alternative embodiment, an optional reflective material may be positioned on the first and/or second angled end to form a reflective surface for directing waves into and/or out of the waveguides 120. In embodiments where the waveguide is an optical fiber such as a plastic optical fiber, heat generated during the milling may smooth the milled surface of the optical fiber, thereby enhancing its reflective properties.

In an exemplary embodiment, after the waveguides have been secured within the grooves (e.g., the epoxy has set), the printed circuit board 100 is turned over (as shown in FIGS. 1 and 2 with the grooves 110 on the lower side of printed circuit board 100). The printed circuit board may then be clamped into a milling machine (not shown), which was previously used to mill the grooves in which the waveguides are embedded. As shown in FIG. 1 and FIG. 2, an end mill 140 may then be lowered to mill through the now uppermost portion of printed circuit board 100 to create a cavity within the printed circuit board 100 that intersects the waveguide 120.

End mill 140 may be repeatedly lowered into the printed circuit board to form holes that intersect each waveguide 120 or end mill 140 may be positioned at a desired depth and then swept in-plane across multiple waveguides 120 to create a cavity is that intersects multiple waveguides in one motion. A 3.2-mm-diameter, angled end mill 140 (available from McMaster-Carr of Robbinsville, N.J.; part no. 2770A61) may be centered over the embedded optical fiber 120 before being lowered into the printed circuit board. It will be understood by one of skill in the art from the description herein that the placement of end mill 140 may be done at any point along the length of the waveguide and that a single original waveguide may be separated by the end mill 140 in multiple places along its length to form multiple separate waveguides 120. Finally, it will be understood by one skilled in the art from the description herein that the end mill 140 may be of essentially any shape or size provided that the end mill is capable of forming the desired angle needed to allow the new end of waveguide 120 to form a suitable internal reflection mirror or, when coated, a suitable reflective surface for reflecting optical signals into and out of the waveguide.

At step 508, oil may be applied during and/or after the mechanical milling of step 506 to remove debris from the angled end created during step 506. The oil may be used to aid in the removal of particles during the milling process. Suitable oil includes lubricating oil available from Alcatel-Lucent of Paris, France (part no. A-119).

At step 510, internal reflection mirrors may be heated and polished to further enhance reflective properties by producing a finer polish. It will be understood by one of skill in the art from the description herein that this step may be omitted (e.g., if a suitable surface is formed in step 506 or a reflective surface is created by positioning a reflective material on the angled end).

One or more of step 506-510 may be repeated as needed to create a complete set of internal reflection mirrors in waveguides embedded within the printed circuit board (i.e., embedded optical links).

### Example

An internal reflection mirror printed circuit board was created through the exemplary steps and embodiments discussed above. This internal reflection mirror printed circuit board was then tested to determine the efficiency of the apparatus. An input light source consisting of a 75 mW 650 nm laser manufactured by Wicked Lasers in Shanghai, China was used to test the reflectivity of the internal reflection mirror formed by the process. The beam diameter was measured using a CCD camera and determined to be 4.5 mm. A lens with a 25 mm focal length was placed approximately 25 mm in front of the beam and focused the light on to an FC-connectorized 62.5/125 μm fiber cable. A snap-on ferrule lens manufactured by WTT Technologies in Canada was placed on the other end of the fiber cable to focus the output. The output was directed at normal incidence to the circuit board, at a vertical stand-off of approximately 3 mm, to provide light to the embedded waveguides. A Thorlabs DET-110 photodetector was coupled to the output side of the circuit board to measure the output signal out of the embedded waveguides.

After this initial setup, the average coupling loss was measured. The average coupling loss for the embedded plastic optical fiber link waveguide was measured to be −3.14±0.32 dB, with a best channel measurement of −2.80±0.13 dB, indicating roughly −1.6 dB loss per reflection on average. Ray tracing techniques were used to determine the theoretical coupling efficiency obtainable by the interconnect technique presented here. A VCSEL source was simulated. The VCSEL source had a divergence of 16° and had an integrated lens on the back side of the chip with a radius of curvature of 2.7 mm and a conic constant of −3.5. The thickness of the chip was 500 μm. With these parameters, a collimated beam of radius 156 μm was established. To study the fabricated system, a 250 μm diameter fiber with a 240 μm core was used. The refractive indices used for the core and the cladding were 1.402 and 1.490, respectively. An epoxy layer with refractive index 1.51 was placed over the fiber to simulate the effect the epoxy has on the coupling.

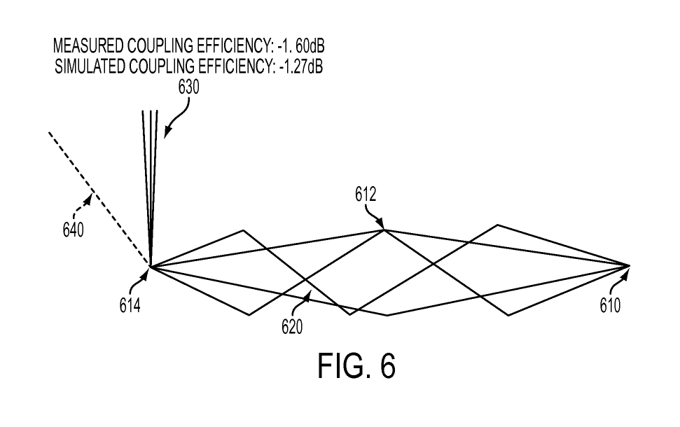

As shown in FIG. 6, optical rays 610 start at a common location at one end the optical fiber 620 on the of right side of FIG. 6. This common source is formed by the laser beam described above. As the optical rays 610 enter the optical fiber 620 they spread out and bounce off the optical fiber walls, for example as shown at point 612. The rays continue to travel through the optical fiber 620 until they reach the internal reflective mirror at point 614. As shown in FIG. 6, the majority of the light reflects out-of-plane in the direction of optical rays 630. Some loss 640 through the mirror surface does occur. In the simulation, loss occurred due to rays that strike the 45 degree surface at an angle that no longer obeys the internal reflection mirror requirements. In reality, this situation is manifested as higher order modes propagating in the multimode fiber that are able to leak through the 45 degree angled surface. The leakage through the reflective surface was calculated to be −9 dB compared to the 90 degree coupled output spot. The total link loss when this leakage was accounted for was calculated to be −1.27 dB.

For the plastic optical fibers used in this experiment, the waveguide loss is −0.030 dB/cm at a wavelength of 850 nm. However, graded index plastic optical fibers typically produce loss less than −0.002 dB/cm and could have readily been substituted for the plastic optical fibers. The ray tracing simulations in this work show that −1.27 dB loss is achievable and that a more refined mirrorization process could achieve even lower loss than reported presently. These ray tracing simulations prove that the method described above and illustrated in FIG. 5 may be used to form an internal reflection mirror that will accurately transmit optical data for chip-to-chip or chip-to-component optical interconnects.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

What is claimed:

1. A method for forming one or more reflective surfaces in one or more waveguides within a printed circuit board, the method comprising:
embedding at least one waveguide within the printed circuit board; and
forming at least one reflective surface in the at least one embedded waveguide using a mechanical mill.

2. The method of claim 1, wherein the at least one reflective surface optically couples a component to the at least one embedded waveguide of the printed circuit board at an incidence substantially normal to a planar surface of the printed circuit board.

3. The method of claim 1, wherein the embedding step comprises:
milling at least one groove into the printed circuit board; and
embedding the at least one waveguide within the at least one milled groove.

4. The method of claim 1, wherein the at least one waveguide is at least one optical fiber.

5. The method of claim 4, wherein the at least one optical fiber is at least one plastic optical fiber.

6. The method of claim 1, wherein the forming step comprises:
mechanically milling the at least one waveguide to separate the at least one waveguide into a first portion and a second portion and simultaneously form a first reflective surface in the first portion and a second reflective surface in the second portion.

7. The method of claim 1, further comprising:
applying oil to remove debris from the formed at least one reflective surface.

8. The method of claim 1, wherein the at least one embedded waveguide includes a plurality of embedded waveguides and wherein the forming step comprises:
mechanically milling a first hole in the printed circuit board that intersects with a first of the plurality of embedded waveguides to form a first reflective surface; and
mechanically milling a second hole in the printed circuit board that intersects with an other of the plurality of embedded waveguides to form a second reflective surface.

9. The method of claim 1, wherein the at least one waveguide includes a plurality of embedded waveguides and wherein the forming step comprises:
mechanically milling a groove within the printed circuit board that intersects at least two of the plurality of embedded waveguides to form a first reflective surface in a first of the at least two waveguides and a second reflective surface in a second of the least two waveguides.

10. The method of claim 1, further comprising:
heating and polishing the reflective surface.

11. The method of claim 1, wherein the at least one reflective surface is at least one total internal reflection mirror.

12. The method of claim 1, wherein the forming step comprises:
mechanically milling the printed circuit board to form at least one angled end on the at least one embedded waveguide; and
coating the at least one angled end of the at least one embedded waveguide with a reflective material.

13. The method of claim 1, wherein the forming step comprises:
mechanically milling the printed circuit board to form at least one internal reflection mirror on the at least one embedded waveguide.

14. An apparatus comprising:
a printed circuit board;
at least one waveguide embedded within the printed circuit board; and
a mechanically milled cavity within the printed circuit board that intersects the at least one waveguide to form at least one angled end on the at least one waveguide.

15. The apparatus of claim 14, wherein the at least one embedded waveguide is at least one optical fiber.

16. The apparatus of claim 15, wherein the at least one embedded waveguide is at least one plastic optical fiber.

17. The apparatus of claim 14, wherein the mechanically milled cavity is a groove.

18. The apparatus of claim 14, wherein the mechanically milled cavity is a hole.

19. The apparatus of claim 14, wherein the mechanically milled cavity separates each of the at least one waveguide into a first portion having a first internal reflection mirror and a second portion having a second internal reflection mirror.

20. The apparatus of claim 14, wherein the at least one reflective surface transmits light passing through the at least one waveguide at an incidence substantially normal to a planar surface of the printed circuit board.

21. The apparatus of claim 14, wherein the at least one angled end forms an internal reflection mirror.

22. The apparatus of claim 14, further comprising:
a reflective material positioned on the at least one angled end to form a reflective surface.
